(19) United States
(12) Patent Application Publication
(10) Pub. No.: US 2005/0254079 A1
(43) Pub. Date: Nov. 17, 2005

(54) Printing apparatus and method enabled to save print option and print document file

(75) Inventor: Yu-rim Han, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/116,262

(22) Filed: Apr. 28, 2005

(30) Foreign Application Priority Data
May 14, 2004 (KR) 2004-34143

(51) Int. Cl. G06F 15/00

(52) U.S. Cl. 358/1.13; 358/1.15; 358/1.1

(57) ABSTRACT

A printing apparatus and method enabled to save a print option and print a document file, comprises the steps of loading an interface relating to a driver program so as to set a print option of a file to be printed in an application program; and changing a print option through a print option setup menu in the interface, and executing a print command with respect to the file to be printed in the print option setup menu. Accordingly, after changing the print option in the application program, the user can print a document file with a minimal key manipulation.

### CROSS-REFERENCE TO RELATED APPLICATION

This application claims the benefit under 35 U.S.C. §119(a) of Korean Patent Application No. 2004-34143 filed on May 14, 2004 in the Korean Intellectual Property Office, the entire disclosure of which is incorporated herein by reference.

### BACKGROUND OF THE INVENTION

1. Field of the Invention

The present invention generally relates to a printing method. More particularly, the present invention relates to a printing method facilitating the printing of a document file after a user changes a print option with respect to the document file.

2. Description of the Related Art

Typically, an inkjet or a laser image forming device receives printing data from a host such as a personal computer, and implements the printing data into an image. Such a host can transmit the printing data to the image forming device only after the installation of a driver program for driving the image forming device. If the user wants to change a print option with respect to a document file, the print option must be set by driving the installed driver program and the set print option is saved in the driver program, thus performing the printing job.

FIGS. 1A and 1B illustrate a conventional method to set up a print option. In detail, FIG. 1A illustrates a Microsoft word processor and a driver program being loaded in the word processor. As shown, after creating an intended document file in an application program 10 such as a word processor, or loading the created document file in an application program 10, when the user wants to print the document file, the user clicks an icon 12 in the application program 10. However, when the user wants to set a print option such as a print resolution, a print range, and the number of sheets, to print the document file, the user loads a driver program 20 by clicking a File tab 11 and a print menu 11a. The loaded driver program 20 shows the basic print options among various print options. To set more detailed print options, the user clicks a Properties tab 23, so that a print option setup menu 23a as shown in FIG. 1B appears on a screen. The print option setup menu 23a of FIG. 1B includes tabs for selecting a layout option, a paper option, a graphic option, an extra option, and an about option. If the user clicks the layout option 23a, the menu as shown in FIG. 1B is displayed on the screen. FIG. 1B illustrates a menu for selecting an orientation of the paper and a menu for selecting the layout options 23b. After selecting the intended print options in the menus, the user clicks a save key 23c to update the driver program, and clicks a OK key 23d or a cancel key 23e to end the setup of the driver program. According to the conventional method, when printing a document created and edited in the application program 10, the user has to click the save key 23c and the OK key 23d, and then clicks the icon 12 of the application program 10 to print the document file. That is, the user needs to click at least three keys 23c, 23d and 12 to print the document with the changed print options. The conventional method is inconvenient for resetting the print options because of the number of steps that must be taken to perform the reset.

### SUMMARY OF THE INVENTION

The present invention has been developed in order to solve the problems discussed above and others associated with the conventional arrangement. An aspect of the present invention provides a printing method enabling a user to print a document file with a minimum key selection after changing a print option of the document file.

To achieve the above feature and aspect of the present invention, a printing method enabling saving a print option and print a document file, comprises the steps of loading an interface relating to a driver program so as to set a print option of a file to be printed in an application program of a host; and changing a print option through a print option setup menu in the interface, and executing a print command with respect to the file to be printed in the print option setup menu.

The print option setup menu comprises a print command key to print the file to be printed with the changed print option applied.

The print command key calls a print command of the application program installed in the host.

The print command is preferably kept in a registry of an operating system of the host.

The changed print option is stored in the driver program.

The host comprises a monitoring part for determining a state of an image forming device.

The changed print option is stored in the monitoring part.

The application program is capable of performing a print job.

An executing step comprises the sub-steps of applying the changed print option to the driver program; and converting the file to be printed, to which the changed print option is applied, into a printing data.

### BRIEF DESCRIPTION OF THE DRAWING FIGURES

These and/or other aspects and advantages of the invention will become apparent and more readily appreciated from the following description of exemplary embodiments, taken in conjunction with the accompanying drawing figures of which:

FIGS. 1A and 1B illustrate a conventional method for setting a print option;

FIG. 2 illustrates a block diagram of a printing system employing a printing method according to an embodiment of the present invention;

FIGS. 3A and 3B illustrate an exemplary driver program according to an embodiment of the present invention; and

FIG. 4 illustrates a flowchart of the printing method of FIG. 2.

Throughout the drawings, it should be understood that like reference numbers refer to like structures, features and elements.

### DETAILED DESCRIPTION OF EXEMPLARY EMBODIMENTS

Reference will now be made in detail to the embodiments of the present invention with reference to the accompanying drawings, wherein like reference numerals refer to the like elements throughout.

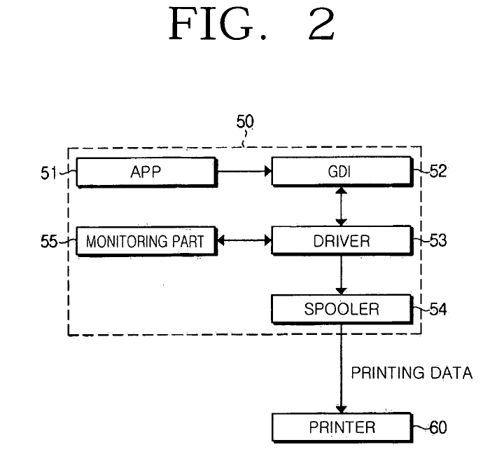

FIG. 2 illustrates an exemplary printing system employing a printing method according to an embodiment of the present invention.

The printing system comprises a host computer 50 and a printer 60. The host computer 50 includes an application program (APP) 51, a graphical device interface (GDI) 52, a driver program 53 (DRIVER), a spooler 54, and a monitoring part 55.

The application program 51 may be a document writing program such as a Microsoft® word processor (e.g., Word), Hangul of Haansoft Inc. or other similar programs. The application program 51 prepares a document file or loads the prepared document file. Hereinafter, the application program 51 centers on a document writing program for the word processing and a corresponding document file. However, it is to be understood that the present invention can be applied to an image program to edit and create an image file and a related image file. For the sake of clarity and conciseness, the Microsoft® word processor application and a document file created in the word processor application are described. The embodiments of present invention can be applied to a graphic processing program capable of creating printing data to be transmitted from the host computer 50 to the printer 60, and an image file edited, loaded and printed in the graphic processing program. Hereinafter, according to an embodiment of the present invention, the descriptions are made of a document file and an application program 51 capable of creating, editing and printing the document file.

The document file prepared in the application program 51 is transmitted to the GDI 52. The GDI 52, which is an interface created by Microsoft®, is provided from the Windows operating systems, for example, Windows 2000 and Windows XP, and installed in the host computer 50 together with the operating system. The GDI 52 acquires font, bitmap and vector information relating to a character or a graphic in the document file, and converts the information to a function recognizable by the driver program 53. Typically, such a function is referred to as a device driver interface (DDI) function. When the user commands to print the document file, the GDI 52 reads resolution information from the driver program 53. The GDI 52 scales the document file to be printed according to the read resolution information and transmits the scaled information to the driver program 53.

The driver program 53 receives the scaled information from the GDI 52 and converts it into printing data recognizable by an image forming device, that is, the printer 60. The converted printing data is buffered in the spooler 54 and transmitted to the printer 60. The printer 60 prints the printing data on paper or other suitable printing media.

The monitoring part 55 stores a print option value set to the driver program 53, and checks out the condition of the printer 60. For instance, if a cover of the printer 60 is open, or, paper and ink or toner are insufficient, the monitoring part 55 can monitor information relating to such a condition and notify the host computer 50 by means of an indicator, such as a character or a graphic or an audible indicator.

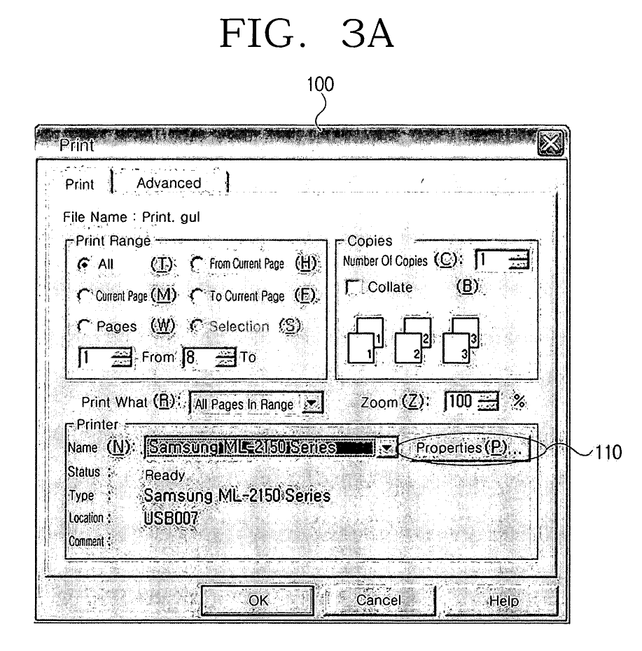

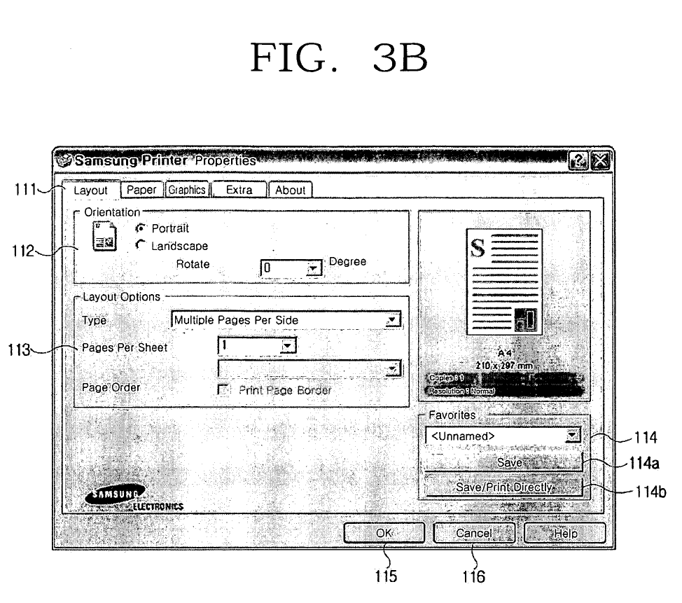

FIGS. 3A and 3B illustrate an exemplary driver program according to an embodiment of the present invention.

FIG. 3A is the driver program 53 shown on a display device of the host computer 50 upon clicking the File tab 11 of the application program 51. If the user clicks a Properties tab 110 in the driver program 53, the driver program 53 is indicated on the display device as shown in FIG. 3B. The displayed driver program 53 comprises a Layout tab 111 for setting layout options, a Paper tab for setting paper options, a Graphics tab for setting graphic options, an Extra tab for setting additional options, and an About tab indicating information relating to the driver program 53. When the user selects the Layout tab 111, orientation setup menu 112 for setting an orientation of a paper, a layout setup menu 113, and a user's favorites setup menu 114 are shown on the display device. Typically, to print the document file, the user selects intended print option, clicks a Save key 114a and an OK key 115 in sequence, closes the driver program 53, and clicks the icon 12 provided from the application program 51. According to an embodiment of the present invention, the driver program 53 provides an additional menu key 114b to save and print directly. When the user sets the print option and clicks the menu key 114b, the print option is saved in the driver program 53 or in the monitoring part 55. After saving, it is programmed to instruct to print in reference to the properties of the application program 51 installed in the host computer 50. For example, a Microsoft® Windows operating system, such as Windows 98, Windows 2000 and Windows XE, can keep an execution command or a print command of an application program installed in the host computer 50 into the registry, and the driver program 53 can print directly in reference to the print command in the registry. In addition, it is possible to program the driver program 53 in a manner that keeps a key value of the icon 12 of the application program 51 so that the application program 51 recognizes the selection of the key value of the icon 12 when the user clicks the menu key 114b to save and directly print the document file.

If the above-mentioned method is applied to the menu key 114b, after changing the print option in the driver program 53, the user can obtain copies with the changed option immediately by clicking the menu key 114b to save and print directly. Whereas in the related art, after changing the print option through the driver program 53, the user saves the print option and prints a document by clicking the save key 114a, the OK key 115, and the icon 12 of the application program. According to an embodiment of the present invention, the user can save the print option value and print the document file by clicking only the menu key 114b to save and print directly.

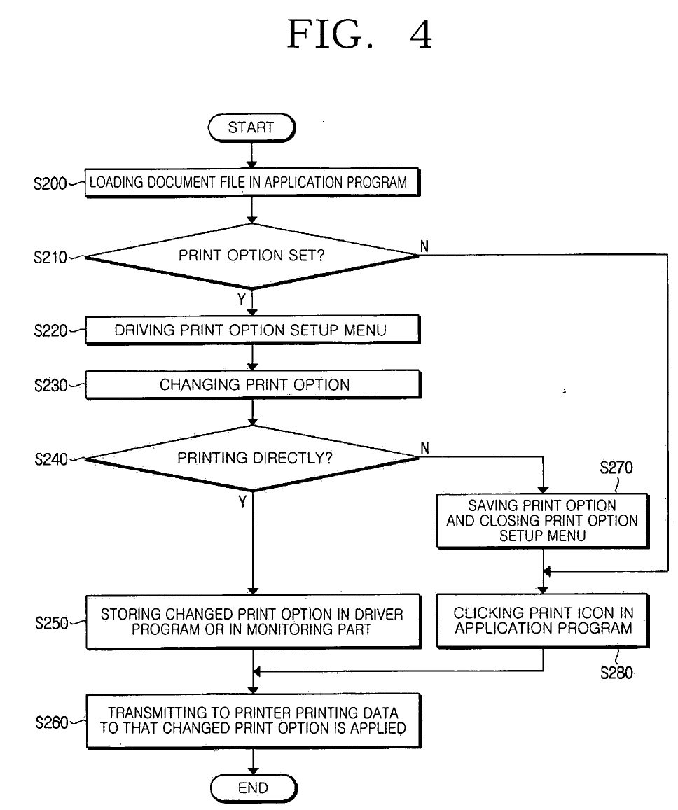

FIG. 4 is a flowchart of a printing method according to an embodiment of the present invention.

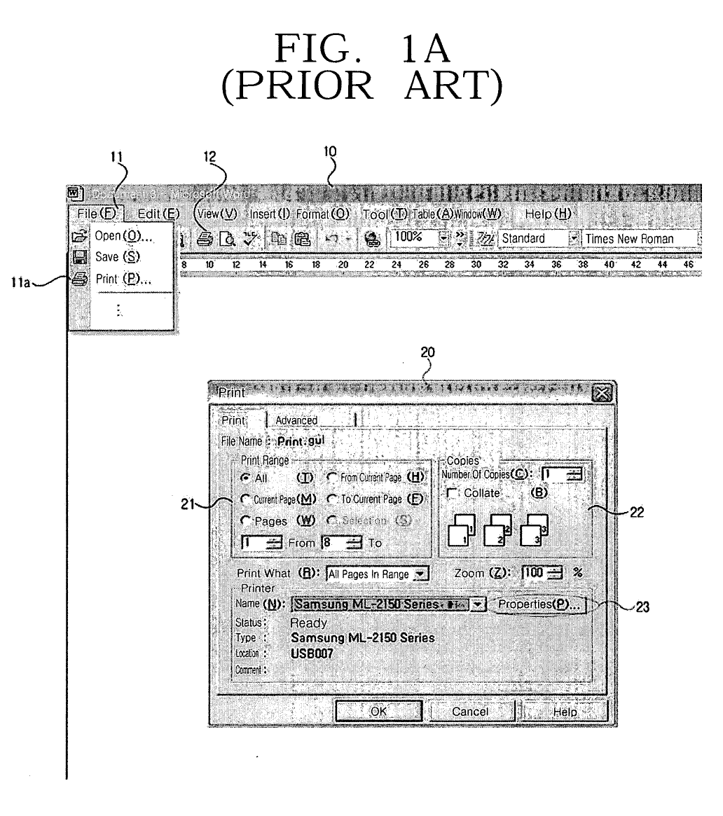

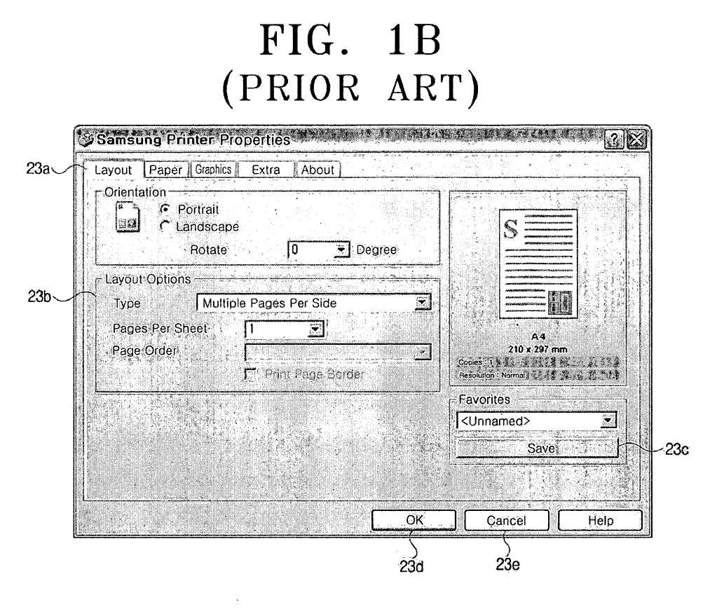

The user executes the application program 51 in the host computer 50 to prepare or edit a document. The application program 51 can be a document preparation program such as a Microsoft word processor or a programming editor such as a Visual C++. The user loads a prepared and edited or pre-created document file in the executed application program 51 (S200). To set the print option of the document file and print the document file (S210), the user drives the driver program 53 installed in the host computer 50, in the application program 51 (S220) as explained in reference to FIG. 1A. The user changes an intended print option through the driver program 53 (S230). The user can select an option to print multiple pages on a print medium, such as paper, an option to scale the document file, an option to set the resolution, and an option to print a watermark over the existing document. After changing such print options, if the user wants to print the document file directly (S240), the user clicks the menu key 114b to save and print directly. Upon clicking the menu key 114b to save and print directly, the driver program 53 stores the changed print option therein or in the monitoring part 55 (S250). The driver program 53 or the monitoring part 55 stores the changed print option in a form of a file or data, and the changed print option is applied to document files edited and prepared by the user in the application program 51. After saving the changed print options, the driver program 53 converts the document file prepared, edited or loaded in the application program 51 into a printing data and transmits to the printer 60 (S260). On the contrary, after changing the print option through the driver program 53, if the user does not want to print directly the document with the changed print option, the user sequentially clicks the save key 114a and the OK key 115 in the driver program 53 and closes the driver program 53 (S270) as in the conventional method. After the user creates or loads another document file in the application program 51, and clicks the icon 12 of the application program 51 (S280), the driver program 53 converts the document file into printing data according to the changed print option and transmits to the printer 60. If the user wants to cancel the changes of the print option after changing the print option in the driver program 53, the user clicks a cancel key 116 and closes the driver program 53.

In light of the foregoing, after changing the print option in the application program, the user can print a document file with a minimal number of inputs. Thus, the convenience for the user of the application is maximized.

While the exemplary embodiments of the present invention have been described, additional variations and modifications of the embodiments may occur to those skilled in the art once they learn of the basic inventive concepts. Therefore, it is intended that the appended claims shall be construed to include both the above embodiments and all such variations and modifications that fall within the spirit and scope of the invention.

1. A printing method enabling to save a print option and print a document file, the print method comprising the steps of:
loading an interface relating to a driver program to set a print option of a file to be printed in an application program of a host;
changing a print option through a print option setup menu in the interface; and executing a print command with respect to the file to be printed in the print option setup menu.

2. The printing method according to claim 1, wherein the print option setup menu comprises a print command key to print the file to be printed with the changed print option applied.

3. The printing method according to claim 2, wherein the print command key calls a print command of the application program installed in the host.

4. The printing method according to claim 3, wherein the print command is stored in a registry of an operating system of the host.

5. The printing method according to claim 2, wherein the changed print option is stored in the driver program.

6. The printing method according to claim 1, wherein the host comprises a monitoring part for determining a state of an image forming device.

7. The printing method according to claim 6, wherein the changed print option is stored in the monitoring part.

8. The printing method according to claim 1, wherein the application program is operable to perform a print job.

9. The printing method according to claim 1, wherein the executing step comprises the sub-steps of:
applying the changed print option to the driver program; and
converting the file to be printed, to which the changed print option is applied, into a printing data.

10. A printing apparatus enabled to save a print option and print a document file, the printing apparatus comprising:
an interface relating to a driver program that is configured to set a print option of a file to be printed in an application program of a host; and
a print option setup menu in the interface configured for changing a print option by executing a print command with respect to the file to be printed in the print option setup menu.

11. The printing apparatus of claim 10, wherein the print option setup menu comprises a print command key to print the file to be printed with the changed print option applied.

12. The printing apparatus of claim 11, wherein the print command key calls a print command of the application program installed in the host.

13. The printing apparatus of claim 12, wherein the print command is stored in a registry of an operating system of the host.

14. The printing apparatus of claim 11, wherein the changed print option is stored in the driver program.

15. The printing apparatus of claim 10, wherein the host comprises a monitoring part for determining a state of an image forming device.

16. The printing apparatus of claim 15, wherein the changed print option is stored in the monitoring part.

17. The printing apparatus of claim 10, wherein the application program is capable of performing a print job.
